(19) United States
(12) Patent Application Publication
(10) Pub. No.: US 2024/0089647 A1
(43) Pub. Date: Mar. 14, 2024

(54) ANTI-LOSS COMPONENT, AND ANTI-LOSS AND STORAGE COMPONENT

(71) Applicant: GOOD NEWS MEDICAL CO., LTD., Keelung City (TW)

(72) Inventor: TUAN-CHUNG WANG, Keelung City (TW)

(21) Appl. No.: 18/355,920

(22) Filed: Jul. 20, 2023

(30) Foreign Application Priority Data
Sep. 13, 2022 (CN) 202222423484.3
Nov. 7, 2022 (CN) 202222986453.9
Mar. 24, 2023 (CN) 202310296476.3

(51) Int. Cl. H04R 1/10

(52) U.S. Cl. CPC H04R 1/1016; H04R 2420/07

(57) ABSTRACT

The anti-loss component of the present invention is used for fastening to a wireless earphone, and the wireless earphone includes a main body part, an earplug part and a clamped part connected to the main body part and the earplug part. The anti-loss component includes: a circlip made of bent metallic wire, wherein the circlip includes a first arm and a second arm; a fastening space located between the first arm and the second arm; a gap linked and located on one side of the fastening space; and a tether connection part located on other side of the fastening space; the gap is used for allowing the circlip to elastically deform when the circlip is fastened to the clamped part; the first arm and the second arm are respectively provided with a guiding structure on two sides of the gap; the fastening space is used for storing the clamped part.

### CROSS REFERENCE TO RELATED APPLICATIONS

This application claims priority of Application No. 202222423484.3 filed in China on Sep. 13, 2022 under 35 U.S.C. § 119; and this application claims priority of Application No. 202222986453.9 filed in China on Nov. 7, 2022 under 35 U.S.C. § 119; and this application claims priority of Application No. 202310296476.3 filed in China on Mar. 24, 2023 under 35 U.S.C. § 119, the entire contents of both of which are hereby incorporated by reference.

### BACKGROUND OF THE INVENTION

### 1. Field of the Invention

The present invention relates to an anti-loss component and an anti-loss and storage component; more particularly, the present invention relates to an anti-loss component for preventing a wireless earphone from being lost and an anti-loss and storage component both for preventing a wireless earphone from being lost and for storing the wireless earphone.

### 2. Description of the Related Art

Currently, the use of the wireless Bluetooth earphone is increasing among consumers, but the only part of the wireless Bluetooth earphone that contacts the human body is the earplug. The earplug connects the wireless Bluetooth earphone to the human body only by being inserted into the human ear, and such a connecting method is not stable. Thus, the wireless Bluetooth earphone can easily be removed from the human ear with minimal force, or in sports such as running, the wireless Bluetooth earphone can easily fall out of the human ear. Due to this design defect of the wireless Bluetooth earphone, the phenomenon of losing the wireless Bluetooth earphone is not uncommon. Given the cost of the wireless Bluetooth earphone, there is a need to design an anti-loss component for preventing the wireless Bluetooth earphone from being lost and an anti-loss and storage component both for preventing the wireless Bluetooth earphone from being lost and for storing the wireless Bluetooth earphone to overcome the abovementioned problem.

### SUMMARY OF THE INVENTION

The object of the present invention is to provide an anti-loss component which is convenient to fasten to the wireless earphone for effectively preventing the wireless earphone from being lost by the user.

To achieve the abovementioned object, the following technical solutions are used in the present invention:

An anti-loss component, for fastening to a wireless earphone, wherein the wireless earphone includes a main body part, an earplug part and a clamped part which is connected to the main body part and the earplug part, the anti-loss component including a circlip, wherein the circlip is formed by bending a metallic wire; the circlip includes a first arm and a second arm which are set relatively; a fastening space located between the first arm and the second arm; a gap located on one side of the fastening space and linking to the fastening space, and a tether connection part located on another side of the fastening space, where the gap is used for allowing the circlip to elastically deform when the circlip is fastened to the clamped part; the first arm and the second arm are respectively provided with a guiding structure on two sides of the gap, and the fastening space is used for storing the clamped part; a tether, where one end of the tether is connected to the tether connection part, and the tether is elastic to allow stretching and buffering when the wireless earphone is removed from a user's ear; a unit, connected to the other end of the tether.

Furthermore, the clamped part passes through the gap to enter the fastening space, the guiding structure touches the clamped part, and at least three contact points are formed between the circlip and the clamped part; the friction between the clamped part and the circlip is low such that the circlip can rotate 360 degrees around the clamped part.

Furthermore, the circlip further includes an elastic part, and the elastic part is connected to the first arm and the second arm and located on an outer side of the fastening space; the tether connection part is located on the elastic part, the two guiding structures and the clamped part form the first and the second contact points, and the third contact point is formed by the clamped part and an end where the first arm is connected to the elastic part or where the second arm is connected to the elastic part.

Furthermore, the tether rotates 360 degrees around the tether connection part via the gap.

Furthermore, the tether is made of a plurality of elastic strings which are combined into a bundle.

Furthermore, the tether is made of a non-static material.

Furthermore, the guiding structure is an outwardly rolling part formed by an end of the first arm and an end of the second arm respectively curling towards the outer side of the fastening space or an inwardly rolling part curling towards the inner side of the fastening space.

Furthermore, the first arm and the second arm both include an extending part, and the two extending parts are correspondingly connected to the two outwardly rolling parts or the two inwardly rolling parts; the two extending parts are located on a same plane, and two free ends of the two outwardly rolling parts or two free ends of the two inwardly rolling parts deviate from the plane defined by the two extending parts.

Furthermore, a curl angle of each of the two outwardly rolling parts or each of the two inwardly rolling parts is between 220° and 270°.

Furthermore, the guiding structure is a ball part.

Furthermore, the circlip is provided with a covering layer, at least three contact points are formed between the circlip and the clamped part, the covering layer is located at least at a part where the circlip contacts the clamped part.

Furthermore, the covering layer is a metal layer or a plastic protective layer.

Furthermore, the first arm and the second arm are provided with a covering layer respectively, the covering layers form the guiding structures respectively on an end of the first arm adjacent to the gap and on an end of the second arm adjacent to the gap, the covering layer is a metal layer or a plastic protective layer.

Furthermore, the circlip further includes an elastic part, the elastic part is connected to the first arm and the second arm and located on an outer side of the fastening space, and the tether connection part is located on the elastic part.

Furthermore, a length of the elastic part protruding outward along a direction away from the fastening space is not more than 4 mm.

Furthermore, the elastic part includes a first elastic arm, a second elastic arm and a center part; the first elastic arm is connected to the center part and the first arm, the second elastic arm is connected to the center part and the second arm, and the tether connection part is located on the center part; a deflection generated by the first elastic arm and the second elastic arm respectively around the center part helps the gap to open to allow the clamped part to pass through the gap and enter the fastening space.

Furthermore, a distance between the first elastic arm and the second elastic arm is less than a size of the gap.

Furthermore, the first elastic arm and the second elastic arm are both straight segments, the first arm and the second arm each respectively includes an extending part which is curved, the extending part of the first arm is connected to the first elastic arm, and the extending part of the second arm is connected to the second elastic arm.

Furthermore, an end of the tether forms a winding part, the winding part bypasses the tether connection part, and two ends of the winding part are tied by a holding hoop.

Furthermore, an end of the tether wraps around the tether connection part at least twice and knots to form a knot structure.

Furthermore, the first arm and the second arm both include an extending part which is curved, the two extending parts are correspondingly connected to the two guiding structures, an end of each of the two extending parts connected to one corresponding of the two guiding structures is close to an end of the other extending part, and a size of the gap is less than a maximum distance defined between the two extending parts.

Furthermore, the unit is another circlip, each of the circlips is fastened to one wireless earphone, a length of the tether is long enough to go around a back of a user's neck

Furthermore, the unit is a holder, and the holder is used for clamping on the user.

Furthermore, the circlip is made of metallic wire having a circular cross-section.

The other object of the present invention is to provide an anti-loss and storage component which is convenient to fasten to the wireless earphone for effectively preventing the wireless earphone from being lost by the user and for containing the wireless earphone.

An anti-loss and storage component includes: an anti-loss component and a storage box, the anti-loss component for fastening to a wireless earphone; the wireless earphone includes a main body part, an earplug part and a clamped part which is connected to the main body part and the earplug part; the anti-loss component includes a circlip, wherein the circlip is formed by bending a metallic wire, the circlip includes a first arm and a second arm which are set relatively, a fastening space is located between the first arm and the second arm, a gap is located on one side of the fastening space and linking to the fastening space, and a tether connection part is located on another side of the fastening space; the gap is used for allowing the circlip to elastically deform when the circlip is fastened to the clamped part; the first arm and the second arm are respectively provided with a guiding structure on two sides of the gap, and the fastening space is used for storing the clamped part; a tether, wherein one end of the tether is connected to the tether connection part, and the tether is elastic to allow stretching and buffering when the wireless earphone is removed from a user's ear; a unit, connected to another end of the tether; the storage box, for storing the wireless earphone, wherein two ends of the tether are contained in the storage box and a center part of the tether is exposed from the storage box and is wrapped around the storage box in a figure 8-shaped binding method.

Unlike a circlip made of plastic, which may be brittle, the circlip formed by bending metallic wire in the present invention has high strength and is not prone to breakage. When the circlip is fastened to the clamped part of the wireless earphone, the clamped part will enter the fastening space; due to the existence of the gap, the ends of the first arm and the second arm located on two sides of the gap near the gap are unconstrained such that elastic stretching can occur on the first arm and the second arm when the clamped part enters the fastening space, and the reaction force generated by the first arm and the second arm can fasten the clamped part tightly into the fastening space; the first arm and the second arm each respectively has the guiding structure on one side of the gap to allow the first arm and the second arm to move to the two sides of the clamped part. It is clear from the above description that the fastening method of the circlip and the clamped part is easy to perform and can effectively prevent the anti-loss component from being detached from the clamped part. One end of the tether of the anti-loss component is connected to the tether connection part of the circlip, and another end is connected to the unit of the anti-loss component, such that the circlip and the unit can be connected together, and the unit and the wireless earphone fastened to the circlip can be connected together; the unit can be installed on a corresponding object according to the requirement of the user to prevent the wireless earphone from separating from the object; the tether is elastic, and it can be stretched when the wireless earphone is removed from the user's ear; unlike a tether which is not elastic, when subjected to an external force, the external force applied on the tether of the present invention will not fully act on the wireless earphone, as a portion of the force will be transferred to the tether to cause it to stretch such that the force transmitted to the wireless earphone is reduced and the possibility of the wireless earphone falling is also reduced; when the wireless earphone applies the external force to the user's ear, the external force on the user's ear is significantly reduced, so the user's ear will not be pulled due to the excessive external force; meanwhile, due to the elasticity of the tether, when the wireless earphone is removed from the user's ear, the wireless earphone will fall due to gravity and the tether will suspend the wireless earphone to prevent the wireless earphone from directly falling to the ground due to gravity.

### BRIEF DESCRIPTION OF THE DRAWINGS

FIG. 1 illustrates an exploded assembly drawing of the anti-loss component and two wireless earphones in the first embodiment of the present invention;

FIG. 2 illustrates a partial top view of the anti-loss component shown in FIG. 1;

FIG. 3 illustrates a side view of FIG. 2;

FIG. 4 illustrates a partial sectional view of FIG. 2 along line A-A;

FIG. 5 illustrates a three-dimensional combination drawing of FIG. 1;

FIG. 6 illustrates a cross-sectional view of FIG. 5;

FIG. 7 illustrates a partial enlarged view of the tether of FIG. 2;

FIG. 8 illustrates a partial exploded assembly drawing of the anti-loss component and the two wireless earphones of other models in the first embodiment of the present invention;

FIG. 9 illustrates a partial schematic drawing of the anti-loss component in the second embodiment of the present invention;

FIG. 10 is a side view of FIG. 9;

FIG. 11 illustrates a partial schematic drawing of the anti-loss component in the third embodiment of the present invention;

FIG. 12 illustrates a sectional view of the circlip in the anti-loss component in the fourth embodiment of the present invention;

FIG. 13 illustrates a partial schematic drawing of the anti-loss component in the fifth embodiment of the present invention;

FIG. 14 illustrates a schematic drawing of the anti-loss component in the sixth embodiment of the present invention;

FIG. 15 illustrates a schematic drawing of the anti-loss and storage component and the wireless earphone in the usage status in the present invention;

FIG. 16 illustrates a schematic drawing of the anti-loss and storage component when the tether is not completely wound from the storage box (wherein the wireless earphone is hidden) in the present invention;

FIG. 17 illustrates a schematic drawing of the tether of FIG. 16 when the tether is wound from the storage box (wherein the wireless earphone is hidden).

### DETAILED DESCRIPTION OF THE PREFERRED EMBODIMENT

In order to make it easier to understand the purpose, structure, features and effects of the present invention, the present invention will be further explained in conjunction with the accompanying drawings and specific implementation methods.

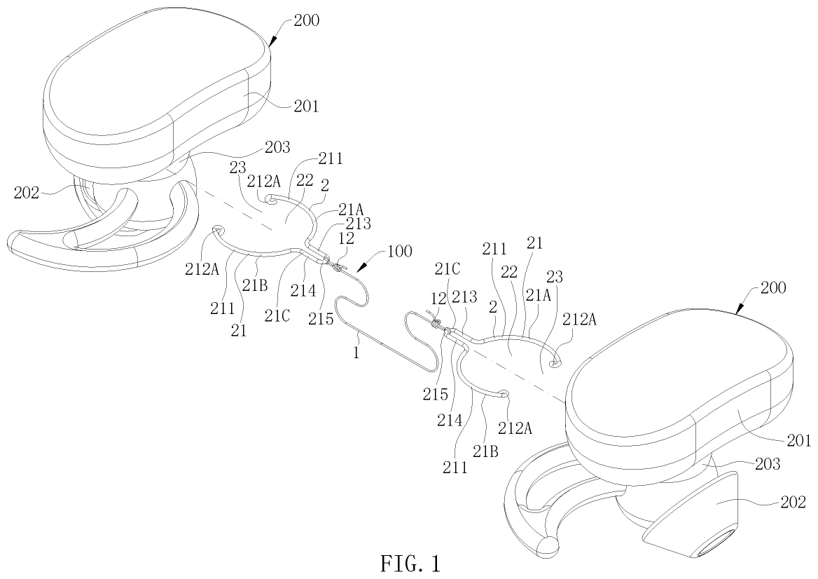

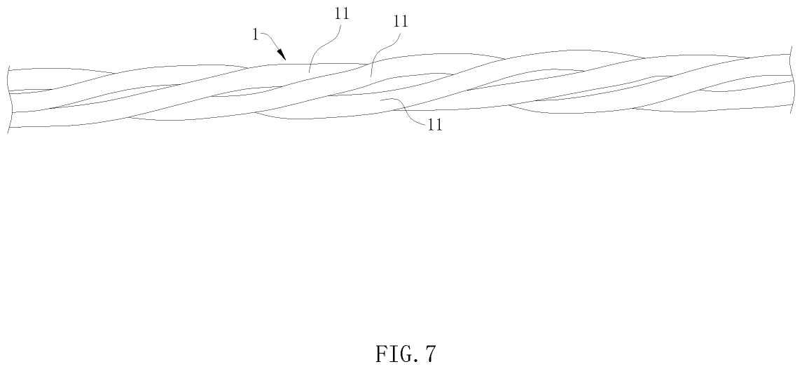

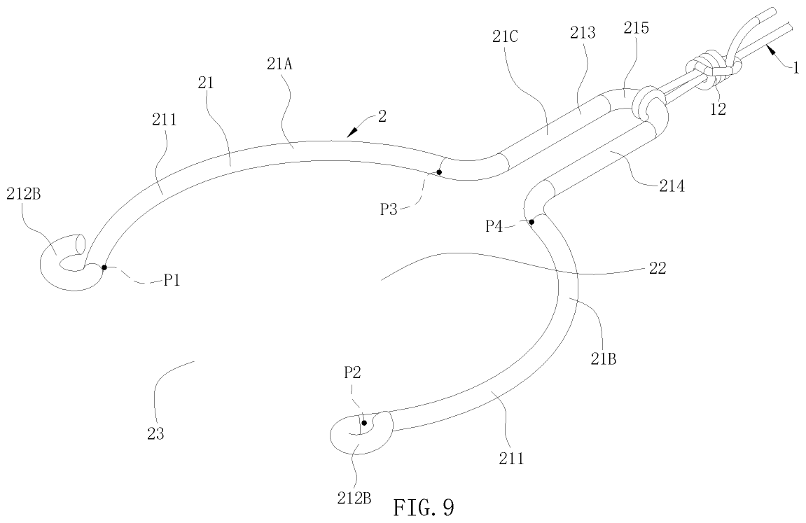

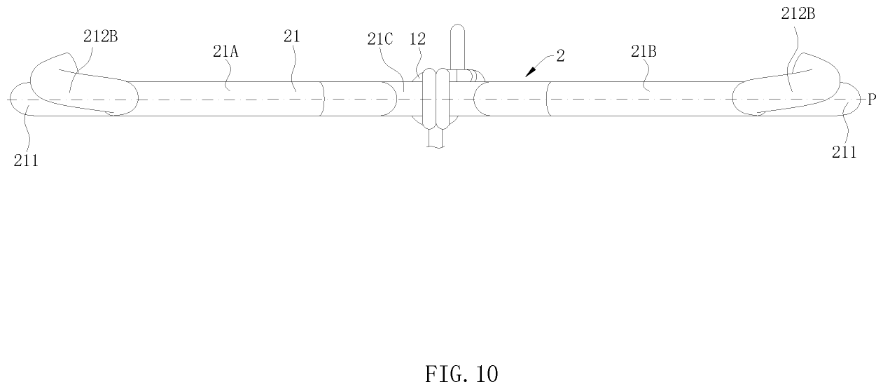

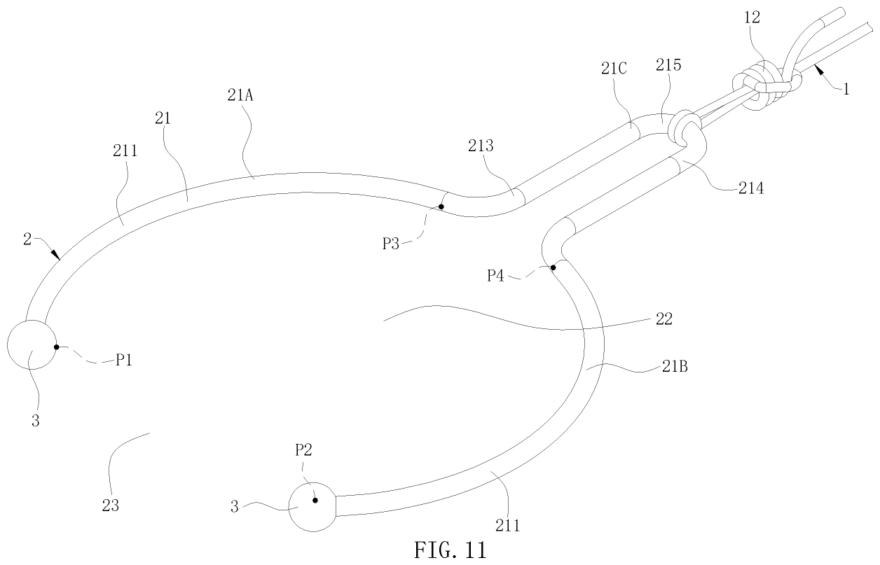

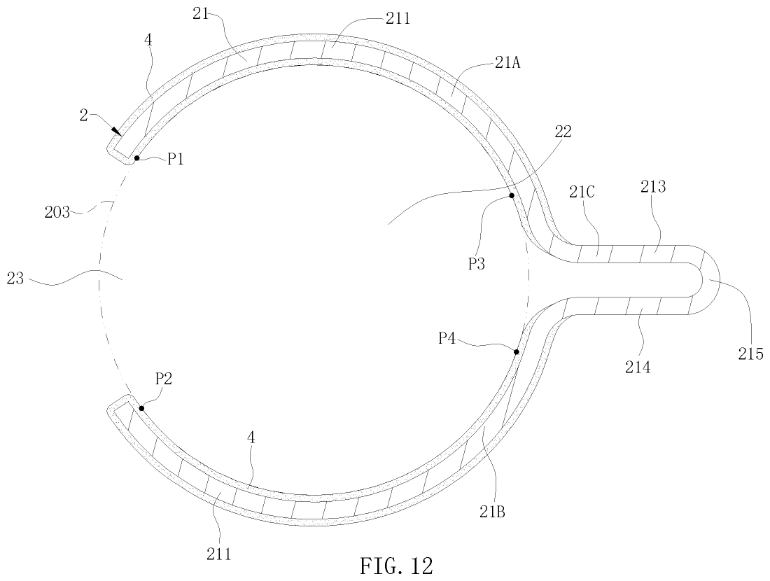

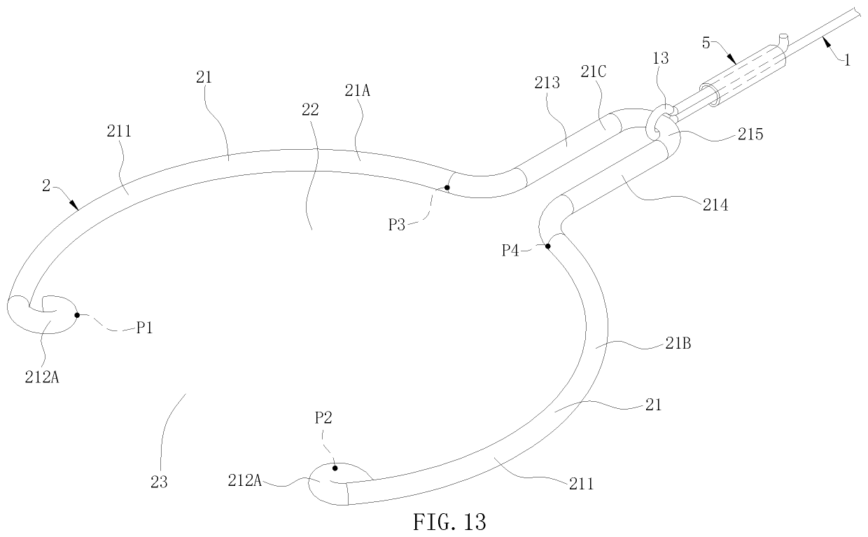

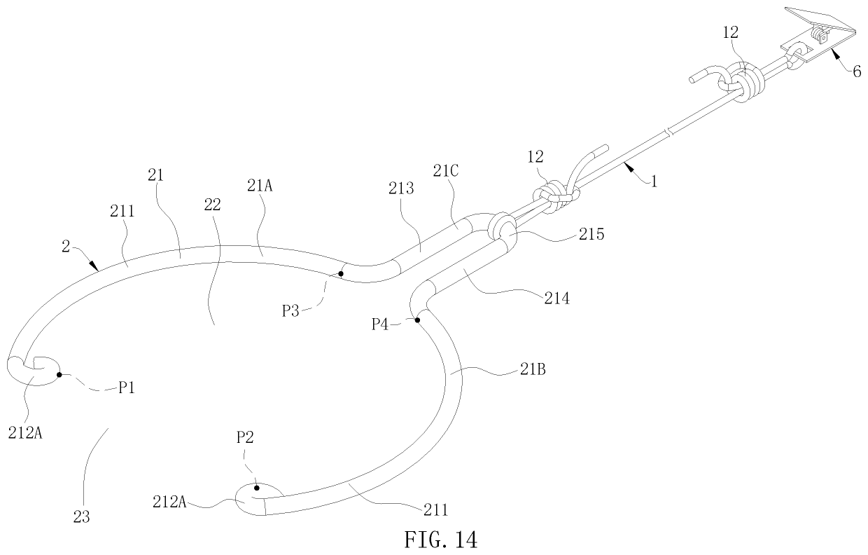

As shown in FIG. 1 to FIG. 14, for the anti-loss component of the present invention, FIG. 1 to FIG. 8 illustrate the anti-loss component 100 in the first embodiment of the present invention, FIG. 9 to FIG. 10 are the anti-loss component 100 in the second embodiment of the present invention, FIG. 11 is the anti-loss component 100 in the third embodiment of the present invention, FIG. 12 is the anti-loss component 100 in the fourth embodiment of the present invention, FIG. 13 is the anti-loss component 100 in the fifth embodiment of the present invention, and FIG. 14 is the anti-loss component 100 in the sixth embodiment of the present invention. In the six embodiments, the anti-loss component 100 can attach a wireless earphone 200 to an object, which means that the wireless earphone 200 and the object are respectively connected to the anti-loss component 100, to prevent the wireless earphone 200 from separating from the object. In the present invention, the wireless earphone 200 can be a wireless Bluetooth earphone, wireless hearing aid, or related object that is inserted into the user's ear to produce sound.

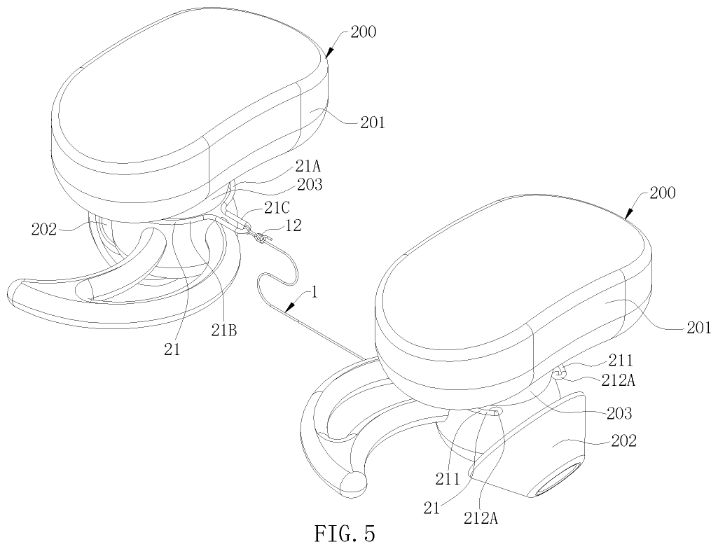

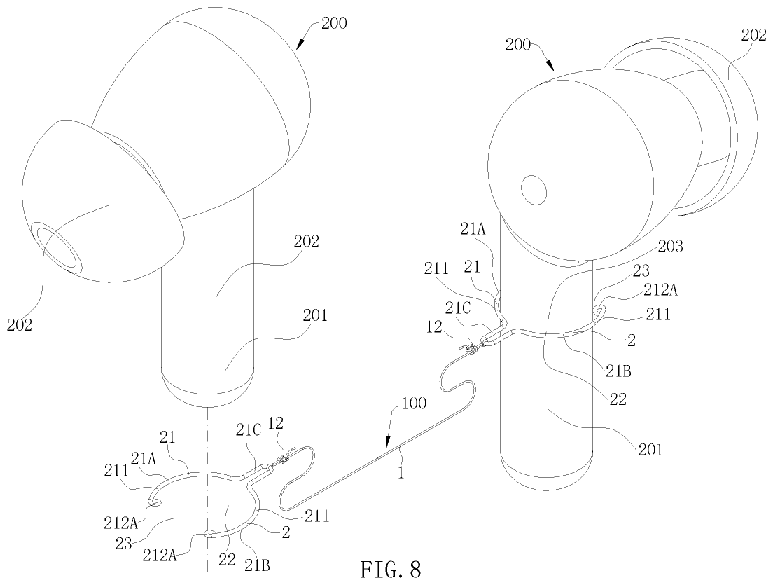

As shown in FIG. 1, FIG. 5 and FIG. 8, in all embodiments of the present invention, the wireless earphone 200 includes a main body part 201, an earplug part 202 and a clamped part 203 connected to the main body part 201 and the earplug part 202. When the wireless earphone 200 is in the usage status, the main body part 201 and the clamped part 203 are exposed to the user's ear, the main body part 201 is provided for the user to grasp when removing the wireless earphone 200, and the earplug part 202 is inserted into the user's ear.

As shown in FIG. 1 and FIG. 5, which illustrate a wireless earphone 200 fastened by the anti-loss component 100 in the present invention, the main body part 201 of the wireless earphone 200 has a “cuboid-like” shape; the earplug part 202 includes a trumpet-shaped part made of deformable rubber, the clamped part 203 is located between the main body part 201 and the earplug part 202, the main body part 201 and the clamped part 203 are a “T-shaped” structure, and the earplug part 202 protrudes laterally on the side corresponding to one long side of the main body part 201.

As shown in FIG. 8, for another model of wireless earphone 200 fastened to the anti-loss component 100 in the present invention, the wireless earphone 200 is L-shaped, and the main body part 201 of the wireless earphone 200 is cylindrical; the earplug part 202 includes a trumpet-shaped part made of deformable rubber (in another embodiment, the earplug part 202 can be made of hard plastic), the clamped part 203 is located between the main body part 201 and the earplug part 202, the clamped part 203 is also cylindrical, and the extension direction of the clamped part 203 and the extension direction of the main body part 201 are the same, and they are coaxial.

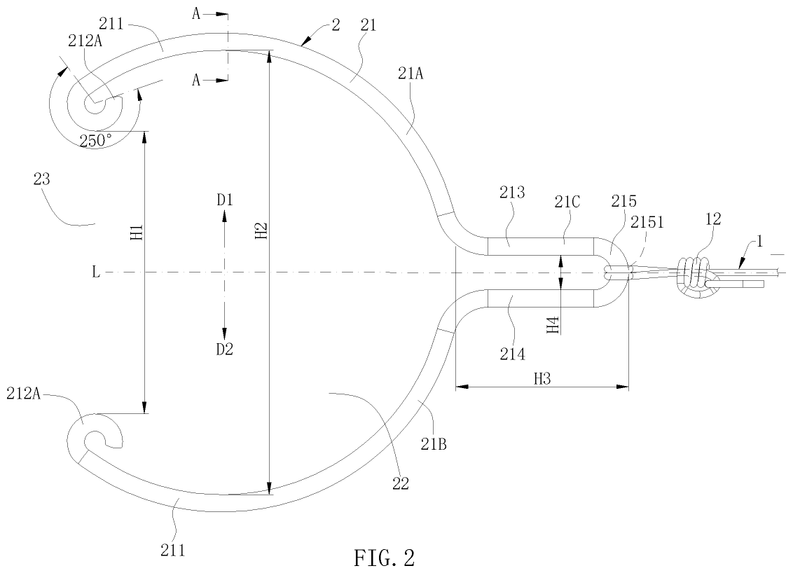

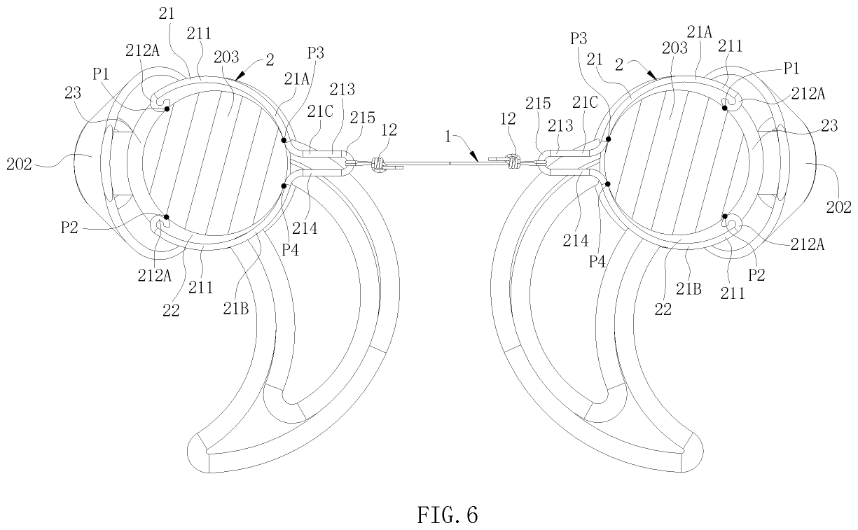

As shown in FIG. 2, FIG. 9, and FIG. 11 to FIG. 14, in all embodiments of the present invention, the anti-loss component 100 includes a tether 1, a circlip 2 connected to one end of the tether 1 and a unit connected to another end of the tether 1, wherein the circlip 2 is fastened to the clamped part 203 of the wireless earphone 200 (as shown in FIG. 5 and FIG. 6) such that the anti-loss component 100 can be connected to the wireless earphone 200.

As shown in FIG. 1, FIG. 5 and FIG. 6, in the first embodiment of the present invention, the unit of the anti-loss component 100 is another circlip 2, which means that the anti-loss component 100 includes a tether 1 and two circlips 2 respectively connected to two ends of the tether 1, and the two circlips 2 are respectively used for fastening a wireless earphone 200 to prevent the two wireless earphones 200 from separating.

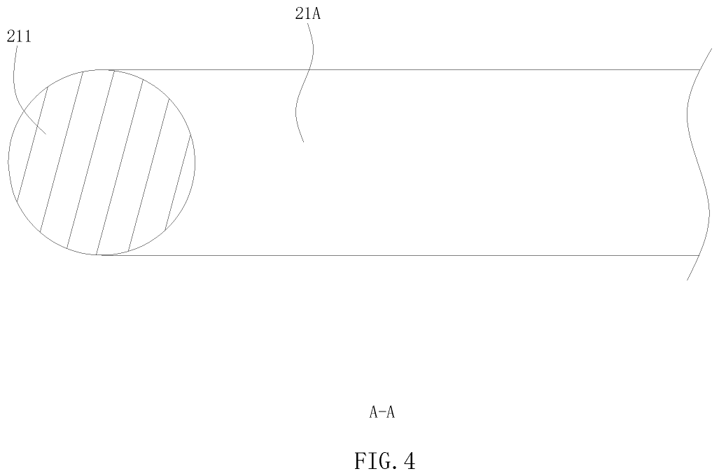

As shown in FIG. 2 and FIG. 4, in this embodiment, each circlip 2 is formed by bending a metallic wire 21. The cross-section of the metallic wire 21 is preferably set in a circle, but it is not limited to a circle; for example, it can be in other shapes, such as a rectangle. Each circlip 2 includes the metallic wire 21, a fastening space 22 formed by the surrounding metallic wire 21, and a gap 23 formed between two free ends of the metallic wire 21, which means that the two free ends of the metallic wire 21 do not connect to form a closed loop. The fastening space 22 is used for storing the clamped part 203, wherein the clamped part 203 can enter the fastening space 22 from the gap 23 or directly enter the fastening space 22; the metallic wire 21 is located on the outer side of the clamped part 203 for clamping the clamped part 203.

As shown in FIG. 1 and FIG. 2, the metallic wire 21 includes a first arm 21A and a second arm 21B, which are spaced apart from each other and arranged opposite to each other, and an elastic part 21C connected to the first arm 21A and the second arm 21B. The fastening space 22 is located between the first arm 21A and the second arm 21B; the elastic part 21C is located on one side of the fastening space 22; two free ends of the metallic wire 21 are respectively corresponded to the ends of the first arm 21A and the second arm 21B and are not connected to the elastic part 21C. It can be seen that the end of the first arm 21A and the end of the second arm 21B which are not connected to the elastic part 21C are located on the two sides of the gap 23. The first arm 21A and the second arm 21B are mirror symmetrical on a central line L, and the central line L extends to pass through the gap 23.

As shown in FIG. 1 and FIG. 2, in this embodiment, each of the first arm 21A and the second arm 21B includes an extending part 211 connected to the elastic part 21C and a guiding structure connected to the extending part 211. The two guiding structures are connected to the end of the extending part 211 of the first arm 21A away from the elastic part 21C, and the end of the extending part 211 of the second arm 21B is away from the elastic part 21C respectively.

As shown in FIG. 1 and FIG. 2, in this embodiment, each of the two extending parts 211 includes a curved segment, and the two ends of the two extending parts 211 connected to the two guiding structures respectively are close to each other. Along the extension direction D1-D2 of a straight line perpendicular to the central line L, the size of the gap 23 is less than the maximum distance defined between the two extending parts 211, which means that along the extension direction D1-D2 of the straight line perpendicular to the central line L, the distance H1 between the ends of the two guiding structures near the gap 23 is less than the maximum distance H2 defined between the two furthest points away from the central line L on the two extending parts 211.

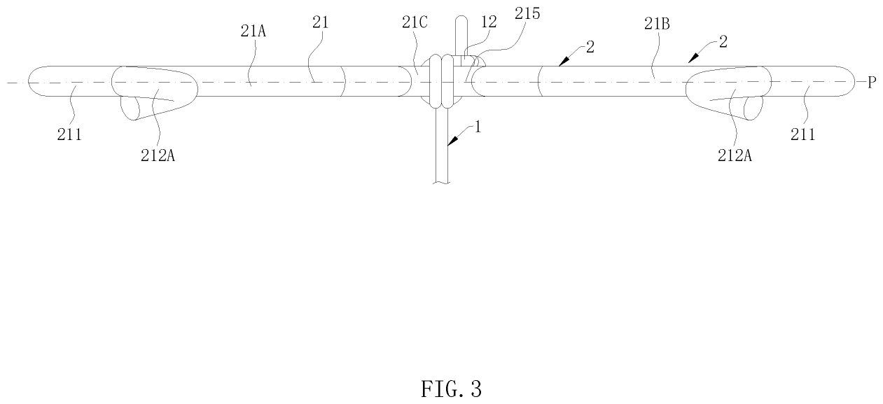

As shown in FIG. 1, FIG. 2 and FIG. 3, in this embodiment, the two guiding structures are two inwardly rolling parts 212A formed by the first arm 21A and the second aim 21B respectively curling from the two extending parts 211 toward the interior of the fastening space 22, and the two inwardly rolling parts 212A curls away from the gap 23. The curl angle of each of the two inwardly rolling parts 212A is between 220° and 270°. The two inwardly rolling parts 212A are used as the two guiding structures to guide the clamped part 203 to pass through the gap 23 and enter the fastening space 22 so as to prevent the clamped part 203 from being scratched when passing through the gap 23 and to avoid scratching the user's ear. The two inwardly rolling parts 212A touch the outer surface of the clamped part 203 such that at least three contact points are formed between the circlip 2 and the clamped part 203 (as shown in FIG. 6). The friction between the clamped part 203 and the circlip 2 is small such that the circlip 2 rotates 360 degrees around the clamped part 203; specifically, the two inwardly rolling parts 212A and the clamped part 203 form the first and the second contact points P1, P2, and the end of the first arm 21A connected to the elastic part 21C or the end of the second arm 21B connected to the elastic part 21C and the clamped part 203 form the third contact point P3. In another embodiment, the two inwardly rolling parts 212A and the clamped part 203 can also form the first and the second contact points P1, P2, the end of the first arm 21A connected to the elastic part 21C and the clamped part 203 form the third contact point P3, and the end of the second arm 21B connected to the elastic part 21C and the clamped part 203 form the fourth contact point P4. The extending part 211 of the first arm 21A, the extending part 211 of the second arm 21B and the elastic part 21C are on the same plane P. The free end of the inwardly rolling part 212A deviates from the plane P, and two free ends of the two inwardly rolling parts 212A are the two free ends of the metallic wire 21. When the circlip 2 is fastened to the clamped part 203, the two free ends of the two inwardly rolling parts 212A which deviate from the plane P can be set to deviate from the earplug part 202 to prevent the two free ends of the two inwardly rolling parts 212A from damaging the user's ear.

As shown in FIG. 1 and FIG. 2, in this embodiment, the elastic part 21C is U-shaped. The elastic part 21C includes a first elastic arm 213, a second elastic arm 214 and a center part 215. The first elastic arm 213 and the second elastic arm 214 are spaced apart from each other, arranged in parallel, and set symmetrically relative to the central line L. The first elastic arm 213 is connected to the center part 215 and the extending part 211 of the first arm 21A, and the second elastic arm 214 is connected to the center part 215 and the extending part 211 of the second arm 21B. The first elastic arm 213 and the second elastic arm 214 are both straight segments. The straight segment of the first elastic arm 213 and the straight segment of the second elastic arm 214 are both parallel to the central line L. The center part 215 is set as a half-arc segment, and the center part 215 is symmetrical to the central line L, which means that the central line L extends and passes through the center of the semicircle segment. The center part 215 has a tether connection part 2151, and the tether connection part 2151 is used for allowing the tether 1 to connect. The length of the elastic part 21C protruding outward along the direction away from the fastening space 22 does not exceed 4 mm; specifically, along the extension direction of the central line L, the straight-line distance H3 between the end of the first elastic arm 213 connected to the extending part 211 and the farthest point of the center part 215 away from the first elastic arm 213 does not exceed 4 mm. The distance between the first elastic arm 213 and the second elastic arm 214 is less than the size of the gap 23, which means that along the extension direction D1-D2 of a straight line which is perpendicular to the central line L, the distance H4 between the first elastic arm 213 and the second elastic arm 214 is less than the distance H1 between the two ends of the guiding structure adjacent to the gap 23.

As shown in FIG. 1, FIG. 2 and FIG. 3, in this embodiment, the tether 1 is made of a plurality of elastic strings 11 which cross each other to combine into a bundle, and the tether 1 is made of a non-static material, which means that the plurality of elastic strings 11 are both made of a non-static material. Two ends of the tether 1 respectively wrap around the two tether connection parts 2151 of the two circlips 2 twice and form two knot structures 12 to connect the tether 1 to the two circlips 2. The tether 1 passes through the gap 23 of one of the two circlips 2 and rotates 360 degrees around the tether connection part 2151; specifically, when the knot structure 12 rotates 360 degrees around the tether connection part 2151, because of the gap 23, the center part of the tether 1 located between the two knot structures 12 is not blocked by other parts of the circlip 2.

As shown in FIG. 9 and FIG. 10, in the second embodiment of the present invention, the only difference between the anti-loss component 100 of the second embodiment and the anti-loss component 100 of the first embodiment is the two circlips 2, the two guiding structures of each circlip 2 are two outwardly rolling parts 212B formed by the first arm 21A and the second arm 21B respectively, the two outwardly rolling parts 212B respectively curl from the two extending parts 211 toward the outside of the fastening space 22, and the two outwardly rolling parts 212B curls away from the gap 23. The curl angle of each of the two outwardly rolling parts 212B is between 220° and 270°. The two outwardly rolling parts 212B guide the clamped part 203 to pass through the gap 23 to enter the fastening space 22. The two outwardly rolling parts 212B contact the clamped part 203. The two free ends of the two outwardly rolling parts 212B deviate from the plane P defined by the two extending parts 211 and the elastic part 21C. The two outwardly rolling parts 212B and the clamped part 203 form the first and the second contact points P1, P2, and the end of the first arm 21A connected to the elastic part 21C or the end of the second arm 21B connected to the elastic part 21C and the clamped part 203 form the third contact point P3. In another embodiment, the two outwardly rolling parts 212B and the clamped part 203 can also form the first and the second contact points P1, P2, the end of the first arm 21A connected to the elastic part 21C and the clamped part 203 form the third contact point P3, and the end of the second arm 21B connected to the elastic part 21C and the clamped part 203 form the fourth contact point P4. The other structures in the second embodiment and the first embodiment are the same, so there is no need for further description.

As shown in FIG. 11, in the third embodiment of the present invention anti-loss component, the only difference between the anti-loss component 100 of the third embodiment and the anti-loss component 100 of the first embodiment is the two circlips 2, the two guiding structures of each circlip 2 are two ball parts 3. The diameter of the ball part 3 is greater than the diameter of the circular section of the metallic wire 21. Each of the ball parts 3 can be made of a metal material and integrated with the first arm 21A or the second arm 21B, and it can also be soldered on the first arm 21A or the second arm 21B. Each of the two ball parts 3 can also be made of a plastic material and injection molded or assembled on the first arm 21A or the second arm 21B. The two ball parts 3 and the clamped part 203 form the first and the second contact points P1, P2, and the end of the first arm 21A connected to the elastic part 21C or the end of the second arm 21B connected to the elastic part 21C and the clamped part 203 form the third contact point P3; in another embodiment, the two ball parts 3 and the clamped part 203 can also form the first and the second contact points P1, P2, the end of the first arm 21A connected to the elastic part 21C and the clamped part 203 form the third contact point P3, and the end of the second arm 21B connected to the elastic part 21C and the clamped part 203 form the fourth contact point P4. The other structures in the third embodiment and the first embodiment are the same, so there is no need for further description.

As shown in FIG. 12, in the fourth embodiment of the present invention, the only difference between the anti-loss component 100 of the fourth embodiment and the anti-loss component 100 of the first embodiment is the two circlips 2, that the outer surface of the first arm 21A and the outer surface of the second arm 21B of each of the two circlips 2 each has a covering layer 4. In this embodiment, the covering layer 4 can be a softer plastic protective layer to prevent scratching of clamped part 203, to prevent the clamped part 203 from detaching from the circlip 2, and the plastic protective layer can be formed by spraying or the like. The covering layer 4 can also be a metal coating formed by processes such as electroplating, chemical plating, etc., such that the circlip 2 made of metal material can be prevented from being corroded, and the circlip 2 can be provided with a bright color, allowing the circlip 2 to be more attractive in appearance. The two covering layers 4 cover the first arm 21A and the second arm 21B respectively, and the two guiding structures are the covering layer 4 on the end of the first arm 21A next to the gap 23 and the covering layer 4 on the end of the second arm 21B next to the gap 23. The covering layer 4 located on the end of the first arm 21A and the covering layer 4 located on the end of the second arm 21B guide the clamped part 203 to pass through the gap 23 to enter the fastening space 22. The covering layers 4 located on the opposite two ends of the first arm 21A and the covering layers 4 located on the opposite two ends of the second arm 21B both contact the clamped part 203 to form four contact points P1, P2, P3, P4, which means that the guiding structure in the fourth embodiment does not include the inwardly rolling part 212A, and the other structures in the fourth embodiment and the first embodiment are the same, so there is no need for further description.

In another embodiment, the covering layers 4 on the opposite two ends of one of the first arm 21A and the second arm 21B and the clamped part 203 form the first and the second contact points P1, P2, the covering layer 4 on the end of the other one next to the gap 23 and the clamped part 203 form the third contact point P3. In other embodiment, the covering layer 4 may be arranged only on the contact portion where the first arm 21A is in contact with the clamped part 203 and the contact portion where the second arm 21B is in contact with the clamped part 203, as the abovementioned description, the number of the contacts points can be three-points contact or four-points or more contact points.

In other embodiment, the covering layer 4 can be arranged on the outer side of the corresponding first arm 21A and second arm 21B in the first embodiment, the second embodiment and the third embodiment, or the entire outer side of the circlip 2, while retaining the guiding structures of the first embodiment, the second embodiment and the third embodiment.

As shown in FIG. 13, in the fifth embodiment of the present invention, the only difference between the anti-loss component 100 of the fifth embodiment and the anti-loss component 100 of the first embodiment is the tether 1, each of the two ends of the tether 1 respectively wraps around the corresponding tether connection part 2151 twice, and they do not knot or form the knot structure 12; each of the two ends of the tether 1 has a winding part 13, the winding part 13 bypasses the corresponding tether connection part 2151, and two ends of the winding part 13 are tied by a holding hoop 5 to connect the tether 1 to the two circlips 2; each of the two winding parts 13 can also wrap the corresponding tether connection part 2151 once, twice or more times. The other structures in the fifth embodiment and the first embodiment are the same, so there is no need for further description.

In another embodiment, the circlip 2 in the fifth embodiment can also be any kind of circlip 2 in the second, the third or the fourth embodiment without limitation; for the structure of the circlip 2 in the fifth embodiment, please refer to the descriptions of the second, the third or the fourth embodiments, and there is no need for further description.

As shown in FIG. 14, in the sixth embodiment of the present invention, the only difference between the anti-loss component 100 of the sixth embodiment and the anti-loss component 100 of the first embodiment is that the unit is not the circlip 2 used for connecting to the wireless earphone 200; instead, it is a holder 6 used for clamping on the user. Specifically, the holder 6 can clamp on the clothing on the user, on the user's ear, or on other object of the user; thus, one end of the anti-loss component 100 of this embodiment is connected to the wireless earphone 200 and another end is connected to the user such that the wireless earphone 200 and the user are connected to each other so as to prevent the wireless earphone 200 being lost by the user. In the sixth embodiment, the connection method of the tether 1 and the holder 6 and the connection method of the tether 1 and any circlip 2 in the first embodiment are the same, which means that one end of the tether 1 wraps around the holder 6 twice and knots to form the knot structure 12. The other structures in the sixth embodiment and the first embodiment are the same, so there is no need for further description.

In another embodiment, the circlip 2 in the sixth embodiment can also be any kind of circlip 2 in the second, the third or the fourth embodiment without limitation; for the structure of the circlip 2 in the sixth embodiment, please refer to the descriptions of the second, the third or the fourth embodiments, and there is no need for further description.

In another embodiment, in the sixth embodiment, the connection method of the tether land the circlip 2 and the connection method of the tether 1 and the holder 6 can also be the connection method of the tether 1 and any circlip 2 in the fifth embodiment without limitation, which means that each of the two ends of the tether 1 respectively has a winding part 13, one of the two winding parts 13 bypasses the tether connection part 2151 of the circlip 2, two ends of the winding part 13 are tied by the holding hoop 5, and the other winding part 13 bypasses the holder 6; two ends of the other winding part 13 are also tied by the holding hoop 5.

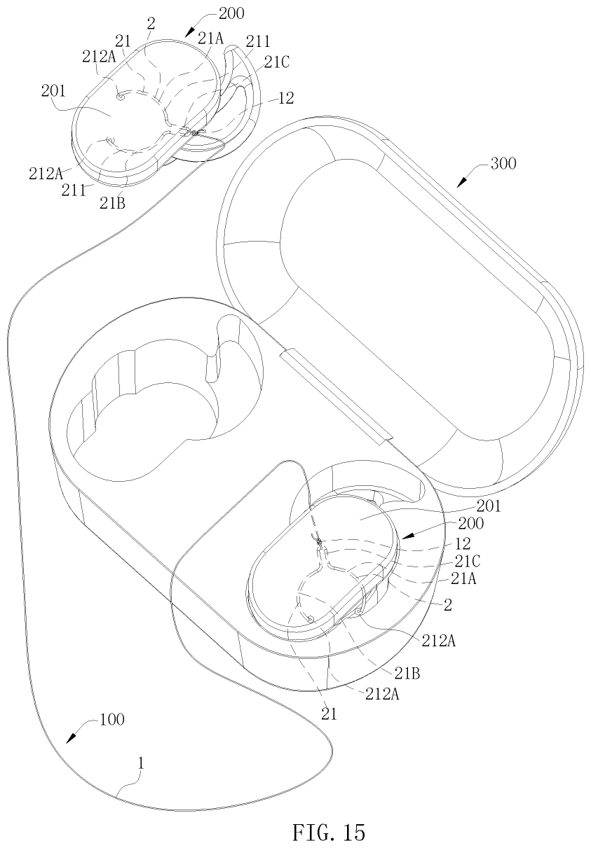

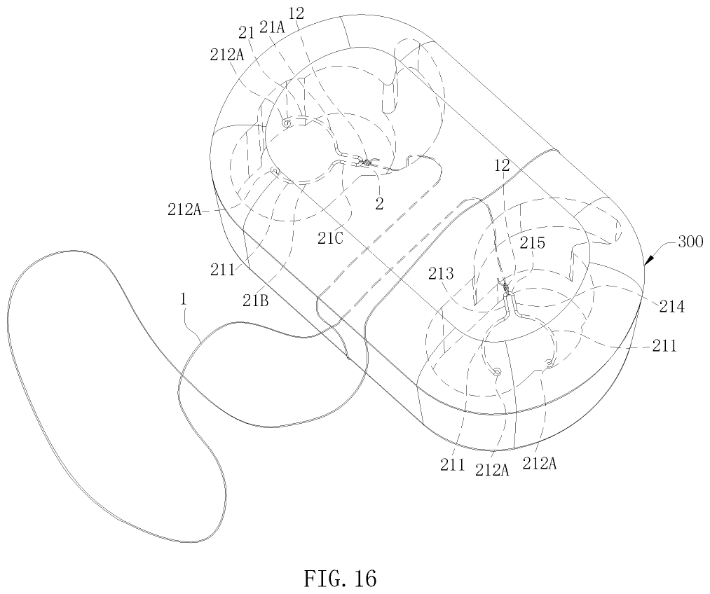

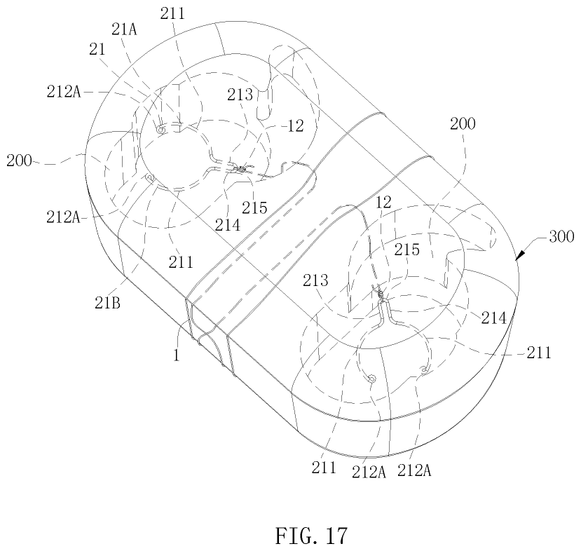

As shown in FIG. 1 and FIG. 15 to FIG. 17, in the present invention, the anti-loss and storage component includes the anti-loss component 100 of the first embodiment and a storage box 300. The storage box 300 is used for storing the two wireless earphones 200. The two circlips 2 of the anti-loss component 100 are fastened to the two clamped parts 203 of the two wireless earphones 200 respectively (shown in FIG. 15) before the two wireless earphones 200 are contained in the storage box 300. When the two wireless earphones 200 are contained in the storage box 300, the two circlips 2 of the anti-loss component 100 and two ends of the tether 1 connected to the two circlips 2 (which means the two knot structures 12) are both contained in the storage box 300, a part of the center part between the two ends of the tether 1 is contained in the storage box, and another part of the center part between the two ends of the tether 1 is exposed from the storage box and is wrapped around the storage box 300 in a figure 8-shaped binding method (as shown in FIG. 16 and FIG. 17). The two circlips 2 of the anti-loss component 100 can also be directly placed in the storage box 300 without being fastened to the two wireless earphones 200.

As shown in FIG. 16 and FIG. 17, the figure 8-shaped binding method means that the center part of the tether 1 exposed from the storage box 300 is first crossed over itself. The center part between the two ends of the tether 1 is divided into two parts by the crossing point as the dividing point, which means that the crossing point is analogous to the intersection point in the middle of the FIG. 8, and the two parts of the center part located on two sides of the crossing point are analogous to the loops on either side of the intersection of the FIG. 8. The center part which is located on the side of the crossing point and outside of the storage box 300 is wrapped around the periphery of the storage box 300. At this moment, the tether 1 is wrapped around the storage box 300 to form the “first loop”; if the tether 1 still has a center part that is not wrapped around the outside of the storage box 300 after forming the “first loop”, the center part that is not wrapped around the outside of the storage box 300 can be crossed again to form a second crossing point, and the center part which is located on the side of the second crossing point and is not wrapped around the outside of the storage box 300 can be wrapped around the periphery of the storage box 300 again to form the “second loop”, and so on. Because the tether 1 is made of an elastic material, which means that the tether 1 is elastic, the user can use the elasticity of the tether 1 to pull the tether 1 until the center part located on the outside of the storage box 300 can be completely wrapped around the storage box 300, and the elastic reaction force of the tether 1 which is wrapped around the outside of the storage box 300 can be used to close the storage box 300 tightly to prevent the wireless earphone 200 in the storage box 300 from dropping out of the storage box 300. Because the tether 1 is wrapped around the outside of the storage box 300, it also ensures that the tether 1 will not separate from the storage box 300, which means that the storage box 300 accommodates not only the wireless earphone 200 but also the tether 1.

In another embodiment, the circlip 2 of the anti-loss and storage component can also be any kind of circlip 2 in the second, the third or the fourth embodiments without limitation. For the structure of the circlip 2 of the another embodiment of the anti-loss and storage component, please refer to the descriptions of the second, the third or the fourth embodiments, and there is no need for further description. The connection method of the circlip 2 and the tether 1 can also be the connection method of the tether 1 and any circlip 2 in the fifth embodiment without limitation. The connection method of the circlip 2 and the tether 1 is described in detailed in the fifth embodiment, and there is no need for further description. The wireless earphone 200 can also be the same structure as the wireless earphone 200 shown in FIG. 8; the wireless earphone 200 shown in FIG. 8 is described in detailed in the first embodiment, and there is no need for further description.

The beneficial effects of the anti-loss component and the anti-loss and storage component of the present invention are as follows:

1) Unlike the circlip 2 made of plastic, which may be brittle, the circlip 2 of the present invention formed by bending the metallic wire 21 has high strength and is not easy to break. When the circlip 2 is fastened to the clamped part 203 of the wireless earphone 200, the clamped part 203 will enter the fastening space 22; because of the gap 23, the ends of the first arm 21A and the second aim 21B located on two sides of the gap 23 and close to the gap 23 are not bound, so they can stretch elastically when the clamped part 203 enters the fastening space 22, and the reaction force generated by the first arm 21A and the second arm 21B can tightly clamp the clamped part 203 in the fastening space 22. Each of the first arm 21A and the second arm 21B has the guiding structure on one side of the gap 23 to allow the first arm 21A and the second arm 21B to conveniently move to the two sides of the clamped part 203. It is clear from the above description that the method by which the circlip 2 is fastened to the clamped part 203 is easy to operate and can effectively prevent the anti-loss component 100 from being detached from the clamped part 203. One end of the tether 1 of the anti-loss component 100 is connected to the tether connection part 2151 of the circlip 2, and another end is connected to the unit of the anti-loss component 100, such that the circlip 2 and the unit are connected to each other, to furthermore connect the wireless earphone 200 fastened to the circlip 2 with the unit. The unit can be set on the corresponding object according to the needs of the user to prevent the wireless earphone 200 from separating from the object. The tether 1 is elastic, so it can be stretched when the wireless earphone 200 is removed from the user's ear. Unlike a tether 1 without elasticity, when subjected to the external force, an external force applied to the tether 1 of the present invention will not fully act on the wireless earphone 200; a portion of the external force will be transferred to the tether 1 to make it stretch, and the force transferred to the wireless earphone 200 is thereby reduced, and the possibility of the wireless earphone 200 falling is also reduced. When the wireless earphone 200 transmits the received external force to the user's ear, the external force on the user's ear will be obviously reduced, which means that the user's ear will not be pulled by an excessive external force. Meanwhile, because the tether 1 is elastic, when the wireless earphone 200 is removed from the user's ear, the wireless earphone 200 will be acted on by gravity, and the tether 1 will suspend the wireless earphone 200 to prevent the wireless earphone 200 from falling directly to the ground because of gravity.

2) The guiding structure contacts the clamped part 203, and at least three contact points are formed between the circlip 2 and the clamped part 203. The circlip 2 does not completely fit the entire outer perimeter of the clamped part 203, and the friction between the clamped part 203 and the circlip 2 is small, such that the circlip 2 can rotate 360 degrees around the clamped part 203.

3) The two guiding structures and the clamped part 203 form the first and the second contact points, and the end of the first arm 21A connected to the elastic part 21C or the end of the second arm 21B connected to the elastic part 21C and the clamped part 203 form the third contact point, wherein the two guiding structures are respectively located on the ends of the first arm 21A and the second arm 21B and the two guiding structures are respectively located on two sides of the gap 23. The end of the first arm 21A connected to the elastic part 21C or the end of the second arm 21B connected to the elastic part 21C is located away from the gap 23, and one of each of the guiding structures is respectively located on the end of the first arm 21A or the second arm 21B. It is clear from the above description that the three points are respectively located on the outside of the fastening space 22 and can be arranged as a triangle, allowing the circlip 2 to contact the clamped part 203 stably.

4) The tether 1 passes through the gap 23 and rotates 360 degrees around the tether connection part 2151; when the tether 1 is knotted, the flexibility of the tether 1 that rotates 360 degrees around the tether connection part 2151 can be used to untangle the knot of the tether 1.

5) The tether 1 is made of a plurality of elastic strings 11 which are combined into a bundle; the plurality of elastic strings 11 are combined to form the tether 1 to enhance the elasticity of the tether 1 so as to prevent the tether 1 from easily being pulled apart. When one of the elastic strings 11 is pulled and broken, the other elastic strings 11 can guarantee the continuity of the tether 1.

6) The tether 1 is made of a non-static material to effectively prevent the tether 1 from generating static electricity due to friction with the user's hair and furthermore prevent the user's hair from being entangled with the tether 1 due to static electricity generated by the tether 1 attracting the user's hair.

7) The guiding structure is the outwardly rolling part 212B, which is formed by curling from the corresponding extending part 211 to the outside of the fastening space 22 to prevent scratching of the outer surface of the clamped part 203 by the free end of the first arm 21A and the free end of the second arm 21B when the clamped part 203 enters the fastening space 22 from the gap 23, which could damage the clamped part 203, and to prevent scratching of the user's ear.

8) The guiding structure is the inwardly rolling part 212A, which is formed by curling from the corresponding extending part 211 to the interior of the fastening space 22, to prevent scratching of the outer surface of the clamped part 203 by the free end of the first arm 21A and the free end of the second arm 21B when the clamped part 203 enters the fastening space 22 from the gap 23, which could damage the clamped part 203, and to prevent scratching of the user's ear.

9) The free end of the outwardly rolling part 212B or the free end of the inwardly rolling part 212A deviates from the plane P defined by the two extending parts 211, such that the metallic wire 21 can easily be bent to form the outwardly rolling part 212B and the inwardly rolling part 212A; when the circlip 2 clamps to the clamped part 203, the free end of the inwardly rolling part 212A which deviates away the plane P can be set away from the earplug part 202 to prevent the free end of the inwardly rolling part 212A from damaging the user's ear.

10) The free end of the outwardly rolling part 212B is located on the inner side of the outwardly rolling part 212B and the free end of the inwardly rolling part 212A is located on the inner side of the inwardly rolling part 212A, and the outwardly rolling part 212B and the inwardly rolling part 212A both curl away from the gap 23, instead of being exposed on two sides of the gap 23, to prevent scratching of the user's ear.

11) The guiding structure is the ball part 3. The surface of the ball part 3 is smooth to effectively prevent the free end of the first arm 21A and the free end of the second arm 21B from scratching the outer surface of the clamped part 203 when the clamped part 203 enters the fastening space 22 from the gap 23 and to prevent damage to the clamped part 203.

12) The guiding structure is the covering layer 4 diposed on the end of the first arm 21A next to the gap 23 and the covering layer 4 diposed on the end of the second arm 21B next to the gap 23; the covering layer 4 can prevent the free end of the metallic wire 21 from being exposed at the two sides of the gap 23 and to prevent the free end of the first arm 21A and the free end of the second arm 21B from scratching the outer surface of the clamped part 203 when the clamped part 203 enters the fastening space 22 from the gap 23, and to prevent damage to the clamped part 203.

13) The tether connection part 2151 is located on the elastic part 21C. The elastic part 21C is connected to the first arm 21A and the second arm 21B and located on the outer side of the fastening space 22. It is clear from this description that, when the tether 1 pulls the elastic part 21C, the pulling force of the tether 1 acting on the elastic part 21C will be buffered by the elasticity of the elastic part 21C and will not directly act on the first arm 21A or the second arm 21B; thus, it will not affect the size of the fastening space 22 or allow the clamped part 203 to separate from the fastening space 22 because of the tether 1 pulling on the elastic part 21C.

14) The length of the elastic part 21C protruding outward along a direction away from the fastening space 22 is not more than 4 mm to prevent the elastic part 21C from being too long and hurting the user's ear when it rotates to be close to the user's ear.

15) The first elastic arm 213 is connected to the center part 215 and the first arm 21A, the second elastic arm 214 is connected to the center part 215 and the second arm 21B, and the tether connection part 2151 is located on the center part 215. The deflection generated by the first elastic arm 213 and the second elastic arm 214 respectively and relatively around the center part 215 facilitates the gap 23 to open to allow the clamped part 203 to enter the fastening space 22 from the gap 23, and the center part 215 will not be excessively elastically deformed, such that the tether 1 can be stably set on the tether connection part 2151 of the center part 215.

16) The distance between the first elastic arm 213 and the second elastic arm 214 is less than the size of the gap 23 such that the user must apply a certain force to open the gap 23 by pressing the first elastic arm 213 and the second elastic arm 214; this design prevents the clamped part 203 from easily being detached from the circlip 2.

17) Each of the two extending parts 211 is respectively connected to an end of the guiding structure and the two guiding structures are close to the other, and the size of the gap 23 is less than the maximum distance defined between the two extending parts 211, such that the clamped part 203 can be stably disposed in the fastening space 22.

18) The unit is the holder 6 which clamps to the user's ear, the cloth or objects on the user, such that one end of the anti-loss component 100 is connected to the wireless earphone 200 and another end is connected to the user to connect the wireless earphone 200 to the user so as to prevent the wireless earphone 200 from being lost by the user.

19) The unit of the anti-loss component 100 is the circlip 2, which means that the anti-loss component 100 includes the tether 1 and two circlips 2 respectively connected on two ends of the tether 1. The two circlips 2 are both used for respectively fastening the wireless earphone 200 to meet the requirement of the user for a pair of wireless earphones 200 and to prevent the two wireless earphones 200 from being lost because the length of the tether 1 is long enough to go around the back of the user's neck.

20) Two ends of the tether 1 are contained in the storage box 300. The center part of the tether 1 is exposed from the storage box 300 and wrapped around the storage box in a figure 8-shaped binding method. It is clear from the above description that the storage box 300 can ensure that the tether 1 is not separated from the storage box 300 without additionally containing the part of the tether 1, and the figure 8-shaped binding method is easy to perform.

Please note that the above embodiments are just preferred embodiments of the present invention and are not intended to limit the scope of the present invention. It is understandable to those skilled in the art that the abovementioned elements are not all essential elements. Furthermore, in order to implement the present invention, other detailed known elements might be included as well. Each element can be omitted or modified according to different needs.

What is claimed is:

1. An anti-loss component, for fastening to a wireless earphone, wherein the wireless earphone comprises a main body part, an earplug part and a clamped part which is connected to the main body part and the earplug part, the anti-loss component comprising:
a circlip, wherein the circlip is formed by bending a metallic wire, the circlip comprises a first arm and a second arm which are set relatively, a fastening space is located between the first arm and the second arm, a gap is located on one side of the fastening space and linked to the fastening space, and a tether connection part is located on another side of the fastening space; the gap is used for allowing the circlip to elastically deform when the circlip is fastened to the clamped part, the first arm and the second arm are respectively provided with a guiding structure on two sides of the gap, and the fastening space is used for storing the clamped part;
a tether, wherein one end of the tether is connected to the tether connection part, and the tether is elastic for stretching and buffering when the wireless earphone is removed from a user s ear;
a unit, connected to the other end of the tether.

2. The anti-loss component as claimed in claim 1, wherein the clamped part passes through the gap to enter the fastening space, the guiding structure touches the clamped part, at least three contact points are formed between the circlip and the clamped part, and a friction between the clamped part and the circlip is low such that the circlip can rotate 360 degrees around the clamped part.

3. The anti-loss component as claimed in claim 2, wherein the circlip further comprises an elastic part, the elastic part is connected to the first arm and the second arm and located on an outer side of the fastening space, the tether connection part is located on the elastic part, the two guiding structures and the clamped part form the first and the second contact points, and the third contact point is formed by the clamped part and an end where the first arm is connected to the elastic part or the second arm is connected to the elastic part.

4. The anti-loss component as claimed in claim 1, wherein the tether rotates 360 degrees around the tether connection part via the gap.

5. The anti-loss component as claimed in claim 1, wherein the tether is made of a plurality of elastic strings which are combined into a bundle.

6. The anti-loss component as claimed in claim 1, wherein the tether is made of a non-static material.

7. The anti-loss component as claimed in claim 1, wherein the guiding structure is an outwardly rolling part formed by an end of the first arm and an end of the second arm respectively curling towards the outer side of the fastening space or an inwardly rolling part curling toward the inner side of the fastening space.

8. The anti-loss component as claimed in claim 7, wherein each of the first arm and the second arm comprises an extending part, the two extending parts are correspondingly connected to the two outwardly rolling parts or the two inwardly rolling parts, the two extending parts are located on a same plane, and two free ends of the two outwardly rolling parts or two free ends of the two inwardly rolling parts deviate from the plane defined by the two extending parts.

9. The anti-loss component as claimed in claim 7, wherein a curl angle of each of the two outwardly rolling parts or each of the two inwardly rolling parts is between 220° and 270°.

10. The anti-loss component as claimed in claim 1, wherein the guiding structure is a ball part.

11. The anti-loss component as claimed in claim 1, wherein the circlip is provided with a covering layer, at least three contact points are formed between the circlip and the clamped part, the covering layer is located at least at a part where the circlip contacts the clamped part.

12. The anti-loss component as claimed in claim 11, wherein the covering layer is a metal layer or a plastic protective layer.

13. The anti-loss component as claimed in claim 1, wherein the first arm and the second arm are provided with a covering layer respectively, the covering layers form the guiding structures respectively on an end of the first arm adjacent to the gap and on an end of the second arm adjacent to the gap, and the covering layer is a metal layer or a plastic protective layer.

14. The anti-loss component as claimed in claim 1, wherein the circlip further comprises an elastic part, the elastic part is connected to the first arm and the second arm and located on an outer side of the fastening space, and the tether connection part is located on the elastic part.

15. The anti-loss component as claimed in claim 14, wherein a length of the elastic part protruding outward along a direction away from the fastening space is not more than 4 mm.

16. The anti-loss component as claimed in claim 14, wherein the elastic part comprises a first elastic arm, a second elastic arm and a center part, the first elastic arm is connected to the center part and the first arm, the second elastic arm is connected to the center part and the second arm, the tether connection part is located on the center part, and a deflection generated by the first elastic arm and the second elastic arm respectively around the center part helps the gap to open such that the clamped part can pass through the gap to enter the fastening space.

17. The anti-loss component as claimed in claim 16, wherein a distance between the first elastic arm and the second elastic arm is less than a size of the gap.

18. The anti-loss component as claimed in claim 16, wherein the first elastic arm and the second elastic arm are both straight segments, each of the first arm and the second arm comprises an extending part which is curved, the extending part of the first arm is connected to the first elastic arm, and the extending part of the second arm is connected to the second elastic arm.

19. The anti-loss component as claimed in claim 1, wherein an end of the tether forms a winding part, the winding part bypasses the tether connection part, and two ends of the winding part are tied by a holding hoop.

20. The anti-loss component as claimed in claim 1, wherein an end of the tether wraps around the tether connection part at least twice and knots to form a knot structure.

21. The anti-loss component as claimed in claim 1, wherein the first arm and the second arm both comprise an extending part which is curved, the two extending parts are correspondingly connected to the two guiding structures, an end of each of the two extending parts connected to one corresponding of the two guiding structures is close to the other, and a size of the gap is less than a maximum distance defined between the two extending parts.

22. The anti-loss component as claimed in claim 1, wherein the unit is another circlip, each of the circlips is fastened to one wireless earphone, a length of the tether is long enough to go around a back of a user's neck.

23. The anti-loss component as claimed in claim 1, wherein the unit is a holder, and the holder is used for clamping on the user.

24. The anti-loss component as claimed in claim 1, wherein the circlip is made of metallic wire having a circular cross-section.

25. An anti-loss and storage component, comprising:
an anti-loss component as claimed in claim 1; and
a storage box, for storing the wireless earphone, wherein two ends of the tether are contained in the storage box, and a center part of the tether is exposed from the storage box and is wrapped around the storage box in a figure 8-shaped binding method.

26. The anti-loss and storage component as claimed in claim 25, wherein the unit is another circlip.
